(19) United States
(12) Patent Application Publication
(10) Pub. No.: US 2026/0187844 A1
(43) Pub. Date: Jul. 2, 2026

(54) IMAGE-BASED CAMERA CALIBRATION SYSTEM FOR DRONE MOUNTED CAMERA

(71) Applicant: PGA TOUR Enterprises, LLC, Ponte Vedra Beach, FL (US)

(72) Inventors: Alex Turnbull, Ponte Vedra Beach, FL (US); Walter Kenneth Lovell, Ponte Vedra Beach, FL (US); Jonas Gredenhag, Ponte Vedra Beach, FL (US); James Japhet, Ponte Vedra Beach, FL (US); Brian Kaufman, Ponte Vedra Beach, FL (US)

(73) Assignee: PGA TOUR Enterprises, LLC, Ponte Vedra Beach, FL (US)

(21) Appl. No.: 19/438,193

(22) Filed: Dec. 31, 2025

Related U.S. Application Data
(60) Provisional application No. 63/740,407, filed on Dec. 31, 2024.

(51) Int. Cl. G06T 7/80; G06T 7/246; G06T 7/90

(52) U.S. Cl. CPC G06T 7/80; G06T 7/248; G06T 7/90; G06T 2207/10016; G06T 2207/10024; G06T 2207/10028; G06T 2207/10032

(57) ABSTRACT

An image-based camera calibration system includes a calibration processor configured to calibrate image frames of a video feed. The calibration processor determines a proposed calibration of the image frame to initialize a refined calibration process that generates a refined calibration. The refined calibration may be generated by rendering a 3D model of the environment captured in the video feed and comparing the rendering to the video feed image and adjusting the proposed calibration values such that the comparison between the rendered image and the image frame is minimized. The system is configured to generate the calibration for sequential images of the video feed in real-time to support live broadcasts without the need for additional data with respect to the camera position, only the video feed.

### CROSS-REFERENCE TO RELATED APPLICATIONS

The present application claims the benefit of U.S. Provisional Patent Application 63/740,407, filed Dec. 31, 2024, the contents of which are hereby incorporated herein by reference.

### TECHNOLOGY

The present disclosure relates to camera calibration. More specifically, the present disclosure relates to systems and methods for generated camera calibration from video feeds of moving cameras.

### SUMMARY

In one aspect, an image-based camera calibration system is configured to execute live drone camera calibration and tracking based on a drone's onboard camera video feed and a 3D model of the environment the drone operates. The system may be configured to remove any need for data off of a camera, such that the video feed off of a drone is the only external input to the system for generating camera calibration. For instance, the system is configured to rely solely on the drone's onboard camera video feed and the 3D model, with no additional sensor data required. In one example, the 3D model includes a high-density LiDAR scan. The system may be specifically configured for use in live broadcast conditions. The system may be configured to maintain reliability with respect to camera calibration even when the drone is traveling at high speeds, e.g., at speeds of approximately 40 mph or more. In some embodiments, the system may incorporate multiple calibration-solving methods to support a wide range of movement scenarios and 3D model conditions, e.g., point clouds, ensuring consistently accurate results with very little latency.

The system may include a calibration processor configured to process raw video to deliver calibration outputs for an image frame in real time, e.g., in under 300 ms. For each frame, the system may provide calibration values such as position coordinates, e.g., x, y, z coordinates, within a coordinate reference frame, camera orientation, or other camera parameters. For example, position coordinates may be output along with values for roll, pitch, and yaw. In a further example, focal length, values for one or more camera distortion parameters, or combination thereof may be output. The system may be configured to output calibrations with respect to sequential image frames at rates up to 60 fps or greater. In one example, the system or calibration processor thereof includes cloud-based, on-premises, or other computing infrastructures, such as servers, to process and deliver the calibration outputs.

For a given frame of video, the calibration processor may be configured to determine a proposed calibration that is close to the true calibration for the camera. Using the proposed calibration, the calibration processor may use a calibration refinement processes comprising a core calibration procedure to refine the proposed calibration and output a refined calibration. This refinement process account for errors in position, orientation, or camera parameters, e.g., errors in position, rotation, zoom, or other calibration values. In various embodiments, this process may be completed using only methods of solving that consist of past, current, and predicted frames and calibrations, wherein no data is required to be ingested or used off of the drone, only the video feed.

Proposed calibrations can be acquired in one or more ways. For example, proposed calibrations may be acquired from calibrations at positions ahead of time. For instance, a drone may be sent to a position and the position recorded as a waypoint. A reference image taken at the waypoint may be calibrated offline to generate a reference calibration, which may be stored for later use. When the drone revisits the waypoint during normal operation, e.g., during a golf tournament, the camera will be proximate enough to the stored reference calibration that the calibration processor may run the calibration refinement process using the reference calibration as the proposed calibration for a current frame of the camera. In one example, the reference image may be generated by taking a reference image grab from the camera at the position and manually associating the reference image to a 3D position within the 3D model, e.g., a point cloud. The calibration may be initially approximated via a virtual camera view within the 3D model. For instance, an operation may manipulate a virtual camera view within the 3D model to a view within the 3D model that approximates the reference image view. The calibration processor may then associate points within the 3D model with pixels in the reference image and fit to a distortion model to further refine this reference calibration to obtain a reference calibration suitable for later use as a proposed calibration to initialize the calibrations during operation of the system.

Additionally or alternatively, proposed calibrations may be automatically discovered from a set of previously calibrated reference images. Given a set of reference images and calibrations, the calibration processor may be configured to determine which calibrated reference image in that set is closest to the current image frame and use that calibration as the proposed calibration for the current image frame. The system may identify interesting features in the reference image and the image frame and match them. This may be done utilizing computer vision procedures. Each of these features in the reference image may be given a 3D position in the 3D model by rendering the model, e.g., point cloud, at that point. Thus, correspondences from the features in the image frame to 3D points may be established. The calibration processor may be configured to solve for calibration values, such as position, rotation, translation, as examples, for the camera given those correspondences with a nonlinear optimization to compute the proposed calibration before refinement. The calibration processor may be configured to perform this step for multiple reference images and pick the solution that gives the best result. Thus, the calibration processor may be configured to choose the closest reference image and compute a proposed calibration that the calibration processor can use as the starting estimate for the calibration refinement process. The system may be configured initialize and run additional calibrations relative to subsequent image frames in the video feed without human intervention.

In some embodiments, the calibration processor is configured to determine a proposed calibration by predicting a proposed calibration from calibrations of previous frames in a video feed. This may include, for example, copying the previous refined calibration or incorporating a motion model when processing sequential image frames of a video feed, e.g., following initiation by one of the above processes or another process that enables calibration of a previous frame. The calibration of a previous frame will generally approximate the true calibration of the current frame, representing a minor change in calibration values arising from movement within the applicable calibration framerate interval, such that the calibration refinement can be run on the proposed calibration predicted from the refined calibration of the previous frame. As noted above, a motion model may also be available for use in generating predictions from the previous calibration to the next, which may be particularly useful to help hold on during faster motion.

In embodiments where a motion model is incorporated, the calibration processor may analyze calibration values from one or more previous frames to identify patterns in camera movement. For example, the motion model may track changes in position coordinates or camera orientation values across sequential frames to determine movement characteristics. The calibration processor may apply these movement characteristics to the previous frame calibration to adjust calibration values for the current frame. The motion model may be particularly useful during periods of sustained motion in a consistent direction or at consistent speeds. In one configuration, the calibration processor may select between copying the previous calibration and applying the motion model based on characteristics of movement detected between frames.

In various embodiments, utilizing a mixture of two or more of the above methods, the system may keep the camera calibrated fast enough as required for use in live broadcast, using only ingested video off the drone or other movable platform mounted camera as an input. Proposed calibrations obtained by such methods may enter the calibration refinement process to produce a refined calibration.

The calibration processor may be configured to execute the calibration refinement process to optimize the proposed calibration and output a refined calibration. The calibration processor may calibrate the camera to the 3D model by rendering the 3D model from the proposed calibration and comparing the rendering to the respective image frame of the video feed. Given the proposed calibration, the calibration processor may optimize the proposed calibration. For example, the calibration processor may adjust the values of the proposed calibration such that a comparison between the rendered image resulting from the 3D model from the proposed calibration and the image frame is minimized. In one configuration, the calibration processor may perform the optimization by minimization of least square error between the rendered image and the image frame. The calibration processor may accelerate the computation of the cost function of the optimization on a GPU to enhance this method in real-time processing.

The system may include a rendering engine configured to render the 3D model from coordinates of a 3D space within which the 3D model is defined. For example, a golf course or other environment within which a camera is to be calibrated may be represented as a 3D scan to a high enough degree of fidelity for the calibration process. This may include, for example, 100s of million points or more. In one example, the 3D model may include a point cloud. In one configuration, the rendering engine employs a data structure configured for efficient querying of a smaller subset of points visible from a given camera or image frame thereof that best represents the scene from that viewpoint. Further areas may be represented by fewer points, areas out of the camera view may be omitted entirely, or both. Implementation of the data structure may enable execution of calibration processes utilizing a fixed, small amount of GPU memory by streaming off CPU memory, disk, or both. Additionally, the smaller subset of points may be utilized to improve rendering speed compared to rendering all points, e.g., an entire point cloud, while still representing the scene with sufficient fidelity for calibration processing during the calibration refinement process.

In various embodiments, the data structure may be configured to vary point density based on distance from the camera position in the proposed calibration. For example, points near the camera position may be selected at higher density than points distant from the camera position. This distance-based selection reduces the total number of points rendered while preserving visual fidelity of features closer to the camera that contribute more significantly to the rendered image. In one configuration, the data structure applies distance-based criteria wherein points beyond certain distance thresholds are selected at progressively lower densities or omitted entirely. The selection of fewer points for distant areas and omission of points outside the camera view enables the rendering engine to operate efficiently while maintaining sufficient fidelity for calibration processing. In various embodiments, the data structure may support spatial queries to identify point subsets efficiently. In various embodiments, spatial querying may include range queries to identify points within specified distances, region queries to identify points within defined areas, or visibility queries to identify points within the camera field of view. The data structure may employ indexing methods such as spatial trees, grid-based partitioning, or hierarchical organizations to accelerate query performance. Query optimization techniques may include early termination of searches when sufficient points are identified or progressive refinement of query results to enhance real-time calibration refinement.

In some embodiments, the rendering engine may maintain information about point locations in central processing unit memory or on disk to enable selective loading of point subsets into graphics processing unit memory. Points visible from the current viewpoint may be loaded into graphics processing unit memory for rendering operations. As the viewpoint changes with subsequent frames, points that are no longer visible may be unloaded and replaced with points that have become visible. This streaming approach allows the rendering engine to operate with a fixed amount of graphics processing unit memory regardless of the total size of the 3D model, enabling operation with point clouds containing hundreds of millions of points using graphics processing units with limited memory capacity. In various embodiments, the 3D model 22 may be managed to handle large-scale point data efficiently. For instance, in some configurations, point cloud compression may be applied to reduce storage and transmission requirements while preserving spatial accuracy for calibration processing. Level-of-detail management, for example, may maintain multiple representations of the point cloud at different resolutions for use based on viewing distance, processing requirements, or otherwise. Data streaming protocols may additionally or alternatively be applied that enable loading and unloading of point cloud sections based on criteria such as camera movement, viewing direction, or combination thereof.

In one embodiment, the system includes an update engine configured to update the 3D model. For instance, the 3D model of the golf course or other mapped environment may not be up to date with respect to the current environment within which the video feed depicts. Given one or more calibrated image frames, such as from the tracking operations of the system or manually calibrated, the update engine may be configured to incorporate colors in the calibrated image into the 3D model rather than colors obtained via mapping, e.g., scan, or previous color updates. This color reference may be used by the calibration processor to improve tracking. The color reference may be updated as the camera moves. This may include updating the color reference utilizing a previously tracked frame. This may lead to gradual drift as small errors accumulate. The update engine may be configured to correct the drift by using various methods to correct a refined calibration. Various methods may be used, including online, offline, or combination thereof. For instance, in one example, slower and more jittery offline methods may be employed that the calibration processor then uses to correct the calibration of a reference frame and gradually incorporates those adjustments into the system. This may be employed to support correction for gradual drift by the system while preserving the smooth tracking from the calibration refinement process with constantly updated color references and maintenance of calibration accuracy over time.

### BRIEF DESCRIPTION OF THE DRAWINGS

The novel features of the described embodiments are set forth with particularity in the appended claims. The described embodiments, however, both as to organization and manner of operation, may be best understood by reference to the following description, taken in conjunction with the accompanying drawings in which:

FIG. 1 is a semi-schematic of an image-based camera calibration system for a drone mounted camera according to various embodiments described herein;

FIG. 2 illustrates an image-based camera calibration method according to various embodiments described herein;

FIG. 3 illustrates an image-based camera calibration method according to various embodiments described herein;

FIG. 4 illustrates an image-based camera calibration method according to various embodiments described herein;

FIG. 5 illustrates an image-based camera calibration method according to various embodiments described herein; and

FIG. 6 is a schematic diagram of a machine in the form of a computer system within which a set of instructions, when executed, may cause the machine to enable image-based camera calibration according to various embodiments described herein.

### DESCRIPTION

Traditional broadcast camera systems employ calibration methods that often depend on a combination of sensors, e.g., sensors internal to a camera, external to a camera, or both, and real-time data streaming to track camera position and orientation in real-time. For instance, robotic or crane-mounted cameras frequently rely on built-in encoders and inertial measurement units (IMUs) to deliver precise position and orientation angle data. Lens encoders are frequently used to supply camera parameter metadata, as well, including zoom and focus values, which can be used to refine calibrations. For aerial or drone-based cameras, GPS-enabled systems and lens-data may be employed to achieve the necessary precision, transmitting positional information to a ground-based system.

In traditional broadcast camera tracking, continuous data exchange between a camera and its calibration system has always been essential, making sensor-driven workflows the backbone of conventional methodologies. However, integrating multiple hardware sensors (IMUs, encoders, GPS units) demands precise alignment, maintenance, and significant setup time. These requirements add expense, operational overhead, and limit both the flexibility and scalability of the system. The limitations are more severe for drones and cameras mounted to drones, where there are strict regulations and codes associated with flying.

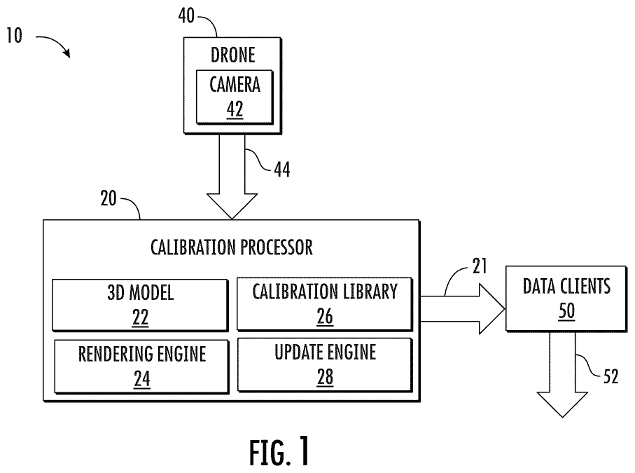

FIGS. 1-7 illustrate features, configurations, components, and methods of image-based calibration of a moving camera as it undergoes movement utilizing the video feed and a 3D model according to various embodiments wherein like features are identified by like numbers.

With specific reference to FIG. 1, illustrating an image-based camera calibration system 10 according to various embodiments described herein, the system 10 may include a calibration processor 20 configured to calibrate a moving camera as it undergoes movement utilizing the video feed collected by the camera 42. The moving camera may be mounted to a drone. A drone refers to an unmanned vehicle or similar platform, such as aerial platforms, capable of carrying and moving a camera. The camera video feed may be calibrated in real time during travel of the camera. The calibration of the video feed may be transmitted during travel for calibration. While examples herein describe calibration of cameras mounted to drones, the systems and methods disclosed are equally applicable to other movable platforms that carry cameras and undergo motion during video capture, including but not limited to robotic arms, cranes, vehicles, which may be manned, and other mobile supports.

The system 10, or calibration processor 20 thereof, may utilize one or more 3D models 22 representative of the environment in which the camera 42 collects the video feed to generate calibration data with respect to the camera 42. The 3D model 22 may be derived from mapping of the area using suitable mapping technologies. Suitable mapping technologies may include, for example, imaging or scanning techniques such as laser, e.g., LiDAR, photography, e.g., photogrammetry, or other suitable techniques. In one example, the 3D model 22 is generated from a LiDAR scan. The LiDAR scan may include, for example, a high-density LiDAR scan. One example 3D model 22 includes a point cloud. The calibration processor 20 may be configured to analyze image frames of the video feed and perform a best fit analysis with respect to previously calibrated images, views taken from renderings of a 3D model of the area, or combination thereof. The calibration processor 20 may analyze a video feed and match image frames frame-by-frame. The calibration processor 20 may be configured to identify pixels and associated features and track movement of the feature from frame to frame to calculate movement and changes in orientation. The calibration processor 20 may use historical data to help constrain calculations. For instance, determination of a pixel location in an image frame at time X, may be tracked to pixel location in a subsequent image frame at time X+1. While the present description generally refers to points with respect to association and correspondence between or among 3D model renderings, 3D model views from rendered points or positions, images, or combinations thereof, it is to be appreciated that features represented in the above may include lines representing surfaces or other features, shapes connecting points, or the like. In addition to or in the alternative to utilizing points, the calibration processor 20 may be configured to utilize such lines, shapes, or the like in the calibration operations described herein, such as when fitting views, determining associations, determining correspondences, or otherwise to compute proposed calibrations for refinement.

The operations of the system 10 may be configured to enable it to process data in a variety data processing infrastructures and configurations. For instance, video feeds 44 may be processed on cloud-based or on-premises servers, for instance, to generate and deliver calibration data outputs 21. In various embodiments, the system 10 may be configured for live broadcast conditions to maintain reliability even when the camera 42 is traveling at high speeds, such as approximately 40 mph or greater. Multiple calibration-solving methods may be employed by the calibration processor 20 to support a wide range of movement scenarios and 3D modeling conditions, ensuring consistently accurate results with very little latency. In various embodiments, the system 10 may maintain processing timing constraints through processing pipeline management and resource allocation. In some configurations, the calibration processor 20 may employ parallel processing pipelines wherein different processing stages operate concurrently on different image frames. Load balancing protocols may be configured to distribute processing tasks across available processing cores or GPUs. The system 10 may monitor processing times and adjust processing parameters, such as point cloud density or optimization iterations, to maintain target frame rates under varying computational loads and enhance real-time calibration requirements.

In various embodiments, operations of the calibration processor 20 may be configured to remove the requirement to collect or utilize any calibration data from the camera or drone beyond the video feed such that the video feed 44 from the camera 42 is the only external input needed for camera calibration. For example, the system 10 may be configured to provide live drone 40 camera calibration data, which may include tracking data, utilizing the video feed 44 captured by the camera 42 and the 3D model 22. Indeed, in some embodiments, calibration and tracking may be performed without any additional sensor data, whether it be onboard or remote location sensing to determine position, orientation, velocity, or the like. For instance, the system 10 may be configured to perform calibration of live video relying solely on an onboard video feed 44 of a drone mounted camera 42 and the 3D model 22, with no additional sensor data required. As noted above, the 3D model 22 may include a LiDAR scan, such as a high-density LiDAR scan.

The system 10 may be configured to process the video, e.g., raw video, to deliver real-time calibration data outputs 21. Various calibration data outputs 21 may be delivered to data clients 50 with respect to image frames of collected video. In one example, calibration data outputs 21 may be delivered in under 300 ms. For example, in some applications, calibration data outputs 21 may be provided for each image frame of a video feed 44 in real-time at 60 fps or more. The calibration data outputs 21 may include, for example, coordinates within a 3D reference frame. The 3D reference frame may be configured within any suitable 3D coordinate space. The 3D coordinate space may be that of the 3D model 22 or a translation with respect to the 3D model 22. Position calibration data outputs 21 may be provided in x, y, z coordinates within such coordinate spaces. Data clients may utilize the calibration data outputs 21 for various applications 52, such as creating artificial reality (AR) renderings within video or other augmented content.

The calibration data outputs 21 may include, for example, camera orientation parameters such as one or more of roll, pitch, or yaw. The orientation may be relative to the position within the 3D reference frame. For example, the orientation may be that taken from a calibration data output camera position. Orientation parameters may be provided as angles relative to base or set position, e.g., relative to one or more coordinate axes. In some embodiments, calibration data outputs 21 may include camera 42 specific parameters such as one or both of focal length or distortion. For instance, the system 10 may be configured to, for every frame, provide x, y, z coordinates along with roll, pitch, yaw, focal length, and camera 42 distortion parameters. Calibration data outputs 21 may include all or combinations of the calibration data generated. In various embodiments, the calibration processor 20 may be configured to determine camera parameters through analysis of the calibration refinement process. In some configurations, focal length may be determined by analyzing a scale relationship between rendered images and image frames during optimization. Additionally or alternatively, camera distortion parameters may be determined by analyzing systematic differences between rendered straight lines and curved lines in an image frame. The calibration processor 20 may be configured to validate camera parameters by comparing results across multiple frames and applying consistency checks. In some configurations, parameter updates may occur gradually to maintain stability in calibration outputs.

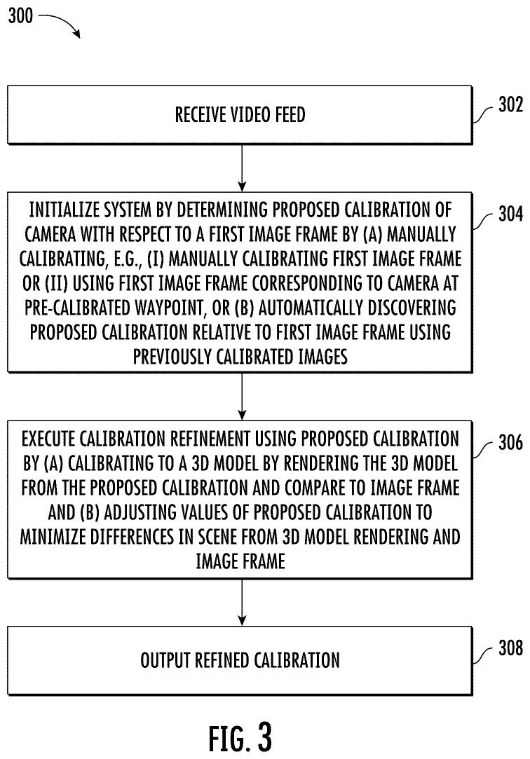

In one embodiment, the system 10 may be configured to initialize calibration for a first image of a video feed 44. For example, a proposed calibration may be determined from a previous calibration. The previous calibration may correspond to a calibration generated at a location corresponding to the location of the camera 42 that collected the image frame to be calibrated. In one example, the corresponding location may be determined from a starting position or waypoint with respect to the location of the camera 42. In another example, the system 10 may be configured to automatically discover a proposed calibration based on analysis of the image frame. For instance, the system 10 may be configured to analyze features in the image frame and compare the features to those in one or more sets of previously calibrated reference image frames to identify one or more reference images that include the features or that otherwise closely approximate the view of the image frame. This may include application of computer vision or other techniques to match features. In one example, 3D positions of the features in the reference images are determined, e.g., utilizing the calibration of the reference images, and applied to the features in the image frame to provide 3D point correspondence to the features. The calibration processor 20 may be configured to then optimize calibration values for the camera 42 given the correspondence. In one embodiment, the calibration processor 20 may perform this process for multiple reference images and pick the solution that gives the best result. Thus, in one example, the calibration processor 20 is configured to choose the closest reference image and compute a proposed calibration that serves as a starting estimate for calibration refinement. After an image frame of a video feed 44 has been calibrated, the calibration processor 20 may be initialized to calibrate subsequent image frames determined from calibrations of the previous image frames in the video feed 44, which, in some embodiments, may include application of a motion model to previous frames. In some embodiments, the calibration processor 20 may be configured to initialize according to method 300 (FIG. 3), described in more detail below.

In various embodiments, the calibration processor 20 may be configured to refine the above calibrations in a calibration refinement process that includes calibrating the camera 42 to a 3D model rendering taken from the above calibrations and comparing the rendering to the respective image frames. For example, the system 10 or calibration processor 20 thereof may include a rendering engine 24 configured to render the 3D model 22 from positions within the model. For example, the camera environment, such as a golf course, may be captured in a 3D scan. The 3D scan may be captured in a high enough degree of fidelity for use in the calibration process. For example, in one embodiment, the fidelity of the 3D scan provides the rendering engine 24 the ability to render the 3D model 22 with 100s of millions of points or more. For instance, the rendering engine 24 may render a point cloud with 100s of millions of points or more. In one embodiment, the calibration processor 20 includes a data structure configured for efficient querying of a small subset of points visible from a given camera 42 that best represents a scene from that viewpoint. In one configuration, fewer points are used to represent distant areas and areas out of the camera view are entirely omitted. In one example, rendering the 3D model 22 utilizing the devised data structure works with a fixed small amount of GPU memory by streaming off CPU memory, disk, or both. To generate refined calibrations, the above calibrations may be used as proposed calibrations that the calibration processor 20 uses to generate a 3D model rendering from the proposed calibration in calibration refinement processing. The calibration refinement processing may include adjusting values of the proposed calibration such that a comparison between the image generated from the 3D model rendering from the proposed calibration and image frame is minimized to produce a refined calibration.

In various embodiments, the system 10 includes an update engine 28 configured to update the 3D model 22, e.g., to keep the 3D model 22 up to date. For example, the 3D model 22 may not be up to date with what is captured in the video feed 44. For instance, new or modified structures (e.g., tee boxes, bunkers, trees, or event infrastructures) may be present. Features may similarly be different colors, e.g., foliage, or richer. The update engine 28 may be configured to incorporate color from a calibrated image into the 3D model 22 to replace colors from an original scan or previous update. For example, colors in the calibrated image may be incorporated at corresponding points in the 3D model 22 to replace previous colors at the points. The calibrated image may be from a library of calibrated reference images or a previous calibrated frame in the video feed 44, as examples. This may be utilized by the calibration processor 20 as a color reference that leads to better tracking. The color reference may be updated as described above as the camera 42 moves. For example, the color reference may be continuously updated by previously tracked frames. This may eventually lead to drift as small errors accumulate. Accordingly, the update engine 28 may be configured to correct the calibration of a reference frame and incorporate the adjustments. For example, drift may be corrected using methods to correct the calibration of a reference frame and the resulting adjustments may be incorporated into the calibration operations. In one configuration, the update engine 28 may be configured to correct for drift by correcting the calibration of a reference frame and incorporating the adjustments. In one example, the offline methods are used to correct the calibration of a reference frame and the update engine gradually incorporates the adjustments into the system 10. Thus, the update engine 28 may be configured to correct for gradual drift while preserving smooth tracking from core calibration processes with constantly updated color references, enhancing calibration accuracy over time.

According to one embodiment, the system 10, the calibration processor 20 receives an input image frame of a video feed 44 for calibration processing. Beneficially, the system 10 may be configured for generating calibration data with respect to live or delayed video feeds 44. Calibration processing may include proposed calibration acquisition and refinement processes. At proposed calibration acquisition, a proposed calibration is determined. For example, for a given frame of video, a proposed calibration is determined using one or more methodologies that is close to the correct or true calibration of the camera with respect to the image frame. As described in more detail below, calibration refinement processes may then be executed to refine the proposed calibration. For instance, the refinement process may be configured to generate a refined calibration that accounts for errors, such as errors in one or more of position, rotation, or zoom in the proposed calibration. As noted above, in various embodiments, the entire process may be completed using only methods of solving that employ one or more of past, current, or predicted frames and calibrations. Thus, the process may be completed without ingesting or using data off the drone 40 other than the video feed 44.

The video feed 44 from the camera 42 may be captured and encoded prior to being received or after being received. For example, the video feed may be captured and encoded when received, e.g., by the calibration processor 20, or the calibration processor 20 or another system 10 component may be configured to one or more of capture or encode the video feed. In an example of the above and other configurations described herein, the video feed is encoded prior to being transmitted to the calibration processor 20 over an internet connection. In one configuration, the video is encoded with standard HD6X codec. As noted above, one or more aspects of the calibration processor 20 may operate in a cloud environment, an on-premises hardware processing environment, an off-premises hardware processing environment, or combination thereof. In various embodiments, the video feed 44 may undergo preprocessing prior to calibration processing. In some configurations, the calibration processor 20 may receive video data in different formats and perform format conversion or decompression as needed. The video feed 44 may be parsed to extract individual image frames for sequential processing. In one configuration, the video feed 44 is processed frame-by-frame at the rate received, such as 60 fps, to maintain real-time calibration output.

As introduced above, the calibration processor 20 may be configured to determine a proposed calibration for a given video frame of the video feed. The calibration processor 20 may utilize one or more processes to determine the proposed calibration. For instance, in some embodiments, a calibration process includes determining a proposed calibration comprising predicting a proposed calibration from previous frames, selecting a previously generated calibration, or automatically discovering a proposed calibration from a set of previously calibrated images. As noted above, in some embodiments, a mixture of methods may be utilized to keep a camera 42 calibrated via application of calibration processes described herein that execute fast enough for use in live broadcast environments.

When receiving a video feed 44, the calibration processor 20 may be configured to perform an initialization process to calibrate a first image of the video feed 44. For example, calibration processing may include an initialization process that includes determining a proposed calibration and a calibration refinement process to calibrate the camera 42 with respect to a first image frame. The calibration with respect to the first image may provide a basis upon which the calibration processing may determine a proposed calibration for a subsequent image frame followed by a calibration refinement process with respect to the subsequent image frame. The calibration with respect to the subsequent image frame may similarly form a basis for calibration of a second, subsequent image frame.

In the initialization process a proposed calibration may be determined for the first image frame. For example, for a given image frame of video, a proposed calibration is determined using one or more methodologies to approximate the true calibration closely enough for refinement with respect to a particular image frame.

The initialization process may include determination of a proposed calibration based on a previously calibrated position. Determination of the proposed calibration may include identifying a previously calibrated position corresponding to the position of the camera 42. The previously calibrated position may have been calibrated beforehand from a reference image taken at the position. This calibration may comprise an initial reference calibration process that the calibration processor 20 may use to provide a proposed calibration for a first image frame in the initialization process. For instance, a drone 40 may be sent to a position and that position may be recorded as a waypoint. A reference image taken by the camera 42 associated with the drone 40 at the waypoint may then be calibrated to obtain a reference calibration for subsequent use in connection with a proposed calibration. Thus, when the drone 40 returns to the waypoint, the camera 42 will be close enough to the position corresponding to the originally calibrated reference image for application of the calibration refinement process using the stored reference calibration as the proposed calibration.

As introduced above, a calibration of a reference image taken at a known position may be used as a proposed calibration in the initialization process. In various embodiments generating a reference calibration for a camera position for subsequent use in the initialization process may include capturing the reference image at a camera position. The reference calibration processing may also include using the reference image to generate the reference calibration by aligning or otherwise associating features in the reference image to the same features represented in a 3D model 22 of an area around the camera position. For example, a reference calibration may be generated by taking the reference image grab from the camera 42 and fitting it to a view representing a 3D position within the 3D model 22, which in some embodiments may comprise point cloud. In this or another example, the reference calibration may include generating an initial approximation of the position within the 3D model 22 that approximates the view of the reference image. For instance, reference calibration generation may include manually identifying an initial approximation of the camera position within the 3D model 22 by comparing the reference image to a virtual camera position within the 3D model 22. For example, an operator may interact with a rendering of the 3D model 22 to move a virtual camera 42. In one embodiment, the reference calibration processing may include associating points within the 3D model 22 with pixels in the reference image to generate the initial calibration. In a further embodiment, the points in the 3D model 22 associated with pixels in the reference image are fitted to a distortion model to further refine the reference calibration for later use as a proposed calibration. In one example wherein an initial approximation of the camera position within the 3D model 22 is identified, associating points within the 3D model 22 with pixels in the reference image and fitting to a distortion model to generate the reference calibration may comprise an offline or otherwise previous calibration refinement process that further refines the initial calibration corresponding to the initial approximation. As noted above, rendering of the 3D model 22 may include utilizing or generating a data structure including a subset of points that best represent the scene from the rendered viewpoint.

In some embodiments, the calibration processor 20 may be configured to determine a proposed calibration of an image frame of a video feed 44 automatically from a set of previously calibrated image frames. Automatic discovery may be utilized as an alternative to the waypoint or manual calibration pathway in the proposed calibration determination portion of the initiation process. The previously calibrated image frames may be available via access to a calibration library including images and associated calibrations. For example, given a set of reference images and calibrations, the calibration processor 20 may be configured to determine which image in the set of images most closely approximates the image frame and utilize the associated calibration as a proposed calibration for the current frame. In a further example, the calibration processor 20 may further process the image frame relative to the set of image frames to solve for calibration values. In one embodiment, the calibration processor 20 is configured to identify corresponding features in the reference images and the image frame and match them. For example, utilizing computer vision, the calibration processor 20 may be configured to find features, e.g., distinct, unique, or interesting features, in a reference image of the set and the image frame and match them. The features may include distinct angles, such as right angles, or feature outlines. This may provide or be used to provide correspondences from features in the image frame to 3D position of the features in the 3D model 22. For example, features in the reference image may be given a 3D position in the model, e.g., a point cloud, by rendering the cloud at that point. The calibration processor 20 may be configured to solve for position/rotation/translation for the camera 42 given the correspondences, e.g., with a nonlinear optimization to compute the proposed calibration. The calibration processor 20 may be configured to perform this for multiple reference images and pick the solution that gives the best result. Thus, the calibration processor 20 may be configured to choose the closest reference image in a set of reference images and compute a proposed calibration as the starting estimate for initiation of the refinement process at the same point, e.g., closest to the same point.

In various implementations, identifying features includes detecting distinctive characteristics in an image frame such as corners, edges, or other recognizable elements. The calibration processor 20 may compute descriptors for the features that characterize the local image properties around each feature. Matching features between the image frame and previously calibrated reference images may include comparing these descriptors to identify correspondences. The calibration processor 20 may apply consistency checks to filter incorrect matches. Matched features may be employed to establish correspondences between locations in the image frame and 3D positions in the 3D model 22, as determined from calibrations of the reference images. The calibration processor 20 may use such correspondences to solve for calibration values to compute the proposed calibration prior to refinement.

In various embodiments, solving for calibration values includes formulating an optimization problem to determine values that minimize error between expected and observed feature positions. For instance, the calibration processor 20 may execute optimization by iteratively adjusting calibration values to reduce the error. The optimization may begin with an initial estimate and refine the estimate through multiple iterations. In one configuration, the calibration processor 20 may execute optimization multiple times with different starting points or different subsets of correspondences and select the result with the lowest error as the proposed calibration.

As introduced above, in some embodiments, the calibration processor 20 may be configured to determine a proposed calibration of an image frame of a video feed 44 by generating a predicted calibration from previous frames. In various embodiments, this may include copying a previous calibration or incorporating a motion model with respect to the previous refined calibration when processing the image frame. For instance, a calibration from a previous image frame will generally be close enough to the true calibration of the current image frame for use as the proposed calibration for application of the calibration refinement process. In one example, once the system 10 has been initialized to generate calibrations for sequential video frames of the video feed 44, a proposed calibration for a current image frame may be the calibration generated for the previous image frame. The calibration for the previous image frame may also be referred to as a refined calibration herein. In some embodiments, a motion model may be employed to better predict the proposed calibration from the previous calibration to the next. Application of a motion model may be utilized during fast motion. When the camera 42 is undergoing predictable motion, the motion model may provide increased accuracy with respect to the proposed calibration. In one example, the calibration processor 20 is configured to analyze previous camera positions determined from calibrations of previous frames, e.g., tracking, to predict motion between a current image frame and a previous image frame. In various embodiments, the calibration processor 20 is configured to predict proposed calibrations for subsequent image frames after initialization of calibration of image frames of a video feed 44 generated for a previous image frame using automatic discovery from a set of previously calibrated images or from a previously calibrated position that corresponds to a current position of the camera 42.

The calibration processor 20 may be configured to execute a calibration refinement processes to refine the proposed calibration. For instance, the refinement process may be configured to generate a refined calibration that accounts for errors, such as errors in one or more of position, rotation, or zoom in the proposed calibration. The refinement processes may optimize the proposed calibration through adjustment of calibration values in the proposed calibration to minimize differences between the proposed calibration and the image frame to output a refined calibration for subsequent inclusion in the calibration data output 21. In the calibration refinement process, the calibration processor 20 may be configured to calibrate a camera 42 to a 3D model 22, such as a point cloud, by rendering the 3D model 22 from a proposed calibration. This proposed calibration may be compared to the video feed 44 off the camera 42. Given the proposed calibration, calibration values may be adjusted such that a comparison between the proposed calibration for an image frame and the image frame is minimized. For example, the image frame may be compared to the rendering from the proposed calibration and the system 10 may calculate values that minimize differences in the views. This may include minimizing differences in the relative position of corresponding features represented by pixels in the image frame and points in the 3D model view. In one embodiment, given a proposed calibration, the calibration processor 20 adjusts the values of the calibration such that a comparison between the rendered image and image frame is minimized, e.g., minimize least squares error between the 3D model rendering and the image frame. In some embodiments, calibration processor 20 is configured to accelerate the computation of the cost function of the optimization on a GPU, enhancing real-time processing, e.g., 60 fps on high-definition footage.

In various embodiments, the calibration processor 20 accelerates computation of the optimization cost function on a GPU by parallelizing residual calculations across multiple processing cores. For example, differences between a rendered image generated from the proposed calibration and the corresponding image frame of the video feed may be computed in parallel for multiple pixels or regions of the image. The GPU may aggregate these residuals into an error measure, such as a least-squares cost function, using parallel reduction operations. The calibration processor may then execute optimization update steps—such as gradient descent, Gauss-Newton, or Levenberg-Marquardt—on the GPU to iteratively adjust calibration values of the proposed calibration to minimize the cost function. In one implementation, by mapping both residual computation and optimization iterations to GPU kernels, the system 10 may be configured to achieve real-time throughput, e.g., completing refinement within approximately 300 ms per frame at frame rates of 60 frames per second or greater.

In various embodiments, the calibration refinement process may include multiple iterations of rendering, comparing, and adjusting. Each iteration may include rendering the 3D model 22 a proposed calibration, computing differences between the rendered image and the image frame, and adjusting calibration values to reduce the differences. The calibration processor 20 may continue iterations until differences fall below a threshold, changes between iterations become minimal, or a predetermined number of iterations is reached, or combination thereof. This iterative approach may enable the calibration processor 20 to refine the proposed calibrations that may differ substantially from the true calibration.

In various embodiments, optimization processing may employ convergence criteria to determine when sufficient refinement has been achieved. In some configurations, convergence may be determined when the cost function falls below a specified threshold, when changes between optimization iterations become smaller than a specified amount, or when a maximum number of iterations is reached. In a further or another configuration, the calibration processor 20 may be configured to employ numerical stability checks to detect divergence or oscillation in optimization parameters. In some arrangements, early termination of optimization may be applied when processing time constraints require completion within target frame rate intervals.

The calibration processor 20 may transmit the calibration data, e.g., a refined calibration, to data clients 50. The calibration data may be sent for every video frame. In one example, the calibration data may be sent at 60 fps or more. Data clients 20 may utilize the calibration data together with the image frames for object tracing operations or creation of AR renderings. In various embodiments, the calibration data may be streamed from the calibration processor 20 to data clients 50 over an internet connection. As noted above, the calibration data stream may be sent at 60 fps or more for every video frame over the internet connection.

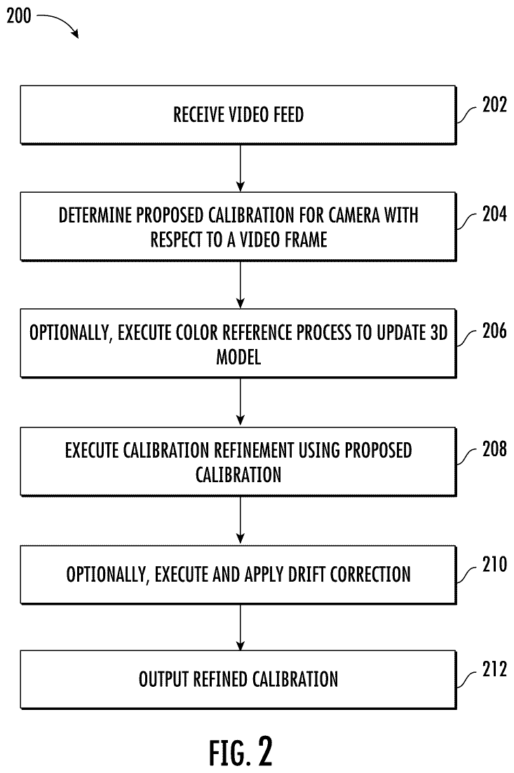

With further reference to FIG. 2, a method of calibrating a drone mounted camera 200 may include receiving a video feed 202. The video feed may comprise one or more image frames of a video feed. While the video feed need not be live, the present disclosure may beneficially provide processing of live video feeds to generate calibration data in real-time sufficient for use in a live broadcast environment. The video feed may be wirelessly transmitted from an onboard wireless transmitter or transceiver. In one embodiment, the video feed signal may be received and transmitted via a suitable protocol for calibration processing. In one example, the video feed signal may be received and transmitted via a serial digital interface or other video signal transmission protocol for calibration processing. In a further or another example, the received video signal may be captured, encoded, and transferred for calibration processing. For example, the video feed signal may be received and transmitted via a serial digital interface and then captured and encoded prior to being transferred for calibration processing, e.g., by the calibration processor 20, described herein. In one example, the captured and encoded video may be transferred over an internet connection for calibration processing. In one configuration, the video is encoded with standard HD6X codec.

The method 200 may include determining a proposed calibration for the camera with respect to a video frame 204. Example methods of determining proposed calibrations for a video frame 204 may include those described above with respect to FIG. 1 or elsewhere herein. In some embodiments, determining proposed calibrations may include using a current location of the camera and a previous stored calibration corresponding to the same approximate location, e.g., waypoint positioning. In this or another embodiment, determining proposed calibrations may include using computer vision to predict a calibration by comparing the image frame to images in a library of calibrated images and using the calibration of a close image as the proposed calibration for the image frame. In a further embodiment, the calibration of the previously calibrated image may be further optimized with respect to the current image frame by determining 3D points of features, as determined from the 3D position of the feature in a 3D model of the area in which the image frame was collected, and then solving for calibration values, e.g., one or more of position, rotation, or translation, for the camera using the 3D points. In one example, this may be performed on multiple previously calibrated images and the best result may be selected for use as a starting point for refinement.. In any of the above or another embodiment, determining a proposed calibration may include predicting a proposed calibration from calibration of previous frames. This may include, copying previous calibration or adjusting values of previous calibrations using a motion model.

The method 200 may optionally include executing a color reference process to update the 3D model 206. For example, the 3D model may be updated using a color reference process that incorporates color from a calibrated image into the 3D model to replace colors from an original scan or previous update. Colors in the calibrated image may be incorporated at corresponding points in the 3D model to replace previous colors at the points. As frames are calibrated, the color reference may be continuously updated by previously tracked frames. The color reference process may be performed when significant movement is detected, or a view change occurs that includes features that have not be updated or had color applied in the color reference process.

In various embodiments, detecting substantial movement includes comparing calibration values between the current frame and previous frames. For example, the update engine may compare position coordinates between frames to calculate distance traveled or may compare camera orientation values to calculate angular displacement. When the distance traveled exceeds a distance threshold, the angular displacement exceeds an angle threshold, or both, the update engine may trigger the color reference process. The thresholds may be configured based on the density of points in the 3D model, the rate of calibration updates, or other factors relevant to maintaining accurate color information in the 3D model. In some embodiments, various thresholds employed by the system 10 may be determined based on one or more operational characteristics, performance requirements, or combination thereof. In one embodiment, movement thresholds for triggering color reference updates may be set based on point cloud density, wherein higher density models may use smaller movement thresholds. Drift thresholds may be established, for example, based on acceptable calibration accuracy for the intended application. In some configurations, matching thresholds for feature correspondence may be determined utilizing descriptor similarity measures. The system 10 may employ adaptive thresholds that adjust based on observed performance metrics or environmental conditions.

The method 200 may include executing a calibration refinement process using the proposed calibration 208. The calibration process may include calibrating to the 3D model by rendering the 3D model from the proposed calibration and comparing to image frame. The calibration process may include adjusting values of the proposed calibration to minimize differences in scene from the 3D model rendering and image frame. In one example, the calibration refinement process may calibrate the camera to the 3D model by rendering the 3D model from the proposed calibration and comparing the rendering to the respective image frame of the video feed. Given the proposed calibration, the proposed calibration may be optimized. For example, the values of the proposed calibration may be adjusted such that the comparison between the image resulting from the rendering of the 3D model from the proposed calibration and the image frame is minimized. In one example, the optimization may include calculating minimization of least square error between the rendered image and the image frame. In one configuration, computation of the cost function of the optimization is accelerated on a GPU for enhanced real-time processing. In one example, a data structure configured for efficient querying of a smaller subset of points in the 3D model visible from a given camera or image frame thereof is employed that best represents the scene from that viewpoint. Further areas may be represented by fewer points, areas out of the camera view may be omitted entirely, or both. Implementation of the data structure may enable execution of the calibration processes utilizing a fixed, small amount of GPU memory by streaming off CPU memory, disk, or both.

The method 200 may optionally include correcting for drift 210. Drift may occur as a result of the color reference process or otherwise. For example, accumulation of small errors over time may result in drift. Drift correction may include tracking of features in sequential image frames over time and determining changes in alignment relative to one or more reference frames and then applying the corrections. In one example, image registration algorithms may be applied. In one embodiment, drift may be corrected by using methods to correct the calibration of a reference frame and the resulting adjustments may be incorporated into the calibration operations. Drift correction may correct drift with respect to the calibration of a reference frame and incorporate the adjustments into the calibration refinement process. Drift correction may be applied to calibrations output from the calibration refinement 208. Drift correction may employ methods to correct the calibration of a reference frame and gradually incorporate those adjustments into calibration operations. For example, when used in combination with the color reference process, correction of gradual drift may be performed while preserving smooth tracking from core calibration processes with constantly updated color references.

In various embodiments, drift may be detected by monitoring error metrics over sequential image frames. For example, the update engine may track residual error from the calibration refinement process over multiple frames. When residual error exhibits an increasing trend, this may indicate accumulation of calibration errors. In another configuration, the update engine may compare predicted calibrations to refined calibrations, wherein increasing discrepancies over time indicate drift. The update engine may calculate adjustments by computing differences between a corrected calibration of a reference frame and the original calibration of that reference frame. Gradual incorporation of adjustments may include applying fractional portions of the adjustments over multiple subsequent frames rather than applying the full adjustment immediately. This preserves smooth tracking by avoiding abrupt changes in calibration values while still correcting accumulated drift over time.

The method 200 may include outputting a refined calibration 212, which may include a refined calibration that has been subject to drift correction. The refined calibration may be output to data clients for various uses. Example uses include creating augmented reality content within the video data, e.g., overlaying augmented reality content over the video data calibrated to the 3D reference frame.

In various embodiments, one or more of receiving a video feed 202, determining a proposed calibration for an image frame 204, executing a color reference process to update a 3D model 206, executing calibration refinement process using the proposed calibration 208, calibrating to the 3D model by rendering the 3D model from the proposed calibration and comparing to the image frame 210, adjusting values of the proposed calibration to minimize differences in the scene from the 3D model rendering and image frame, executing and applying a drift correction 210, or outputting a refined calibration 212, are performed as described with respect to system 10 or elsewhere herein, e.g., FIGS. 3-6. In one embodiment, system 10 may be configured to perform method 200.

In one embodiment, determining a proposed calibration for a video frame 204 within method 200 may include performing an initialization process to initialize the method for performing camera calibrations on subsequent image frames using refined calibrations of previous frames.

With further reference to FIG. 3, a method of calibrating a drone mounted camera 300 may include receiving a video feed 302, which may or may not be a live video feed. The video feed may be one or more image frames. The method 300 may be similar to method 200 described above and include an initialization process. For example, the method 300 may including initializing the calibration process by determining a proposed calibration of the camera with respect to a first image frame by (a) manually calibrating, e.g., (i) manually calibrating the first image frame or (ii) using the first image frame corresponding to the camera at pre-calibrated waypoint, or (b) automatically discovering proposed a calibration relative to the first image frame using previously calibrated images 304.

In one example, a proposed calibration may be determined using a previous calibration, e.g., a reference calibration, calculated ahead of time with respect to the camera at a same or proximate position as the camera when the image frame was collected. The position may comprise a waypoint calibration, which may be calculated as described above, such as utilizing manual calibration techniques. According to one method, determining a proposed calibration includes positioning the camera at the waypoint or determining the camera to be positioned at the waypoint and setting the proposed calibration for an image frame collected at that time to the waypoint calibration. In one embodiment, determining a proposed calibration includes automatically discovering the proposed calibration using previously calibrated images. A library of calibrated images and the image frame may be analyzed using computer vision to identify one or more images including the same features as the image frame. This may be used to identify an approximate match between the image views in the library of images and the image frame. The corresponding features in the calibrated images may be used to identify 3D points of the features. Calibration processing may solve for calibration values to compute proposed calibration of the previously calibrated image frame to that in the current image frame. In one example, non-linear optimization may be applied to solve for calibration values such as position, rotation, and translation for the camera given the correspondences to generate the proposed calibration for use as a starting estimate. In one example, this may be performed on multiple previously calibrated images and the best result may be selected for use as the proposed calibration.

The method 300 may include executing a calibration refinement process using a proposed calibration by (a) calibrating to a 3D model by rendering the 3D model from the proposed calibration and comparing to the image frame and (b) adjusting values of proposed calibration to minimize differences in scene from 3D model rendering and image frame 306. The method 300 may further include outputting the refined calibration 308. In various embodiment, determining the proposed calibration, executing the refinement process, or both are performed as described with respect to method 200, system 10, or elsewhere herein. In one embodiment, the method 300 may further include calibrating subsequent image frames. In one example, calibrating subsequent image frames may be performed according to method 200, method 400, or as described with respect to system 10 or elsewhere herein.

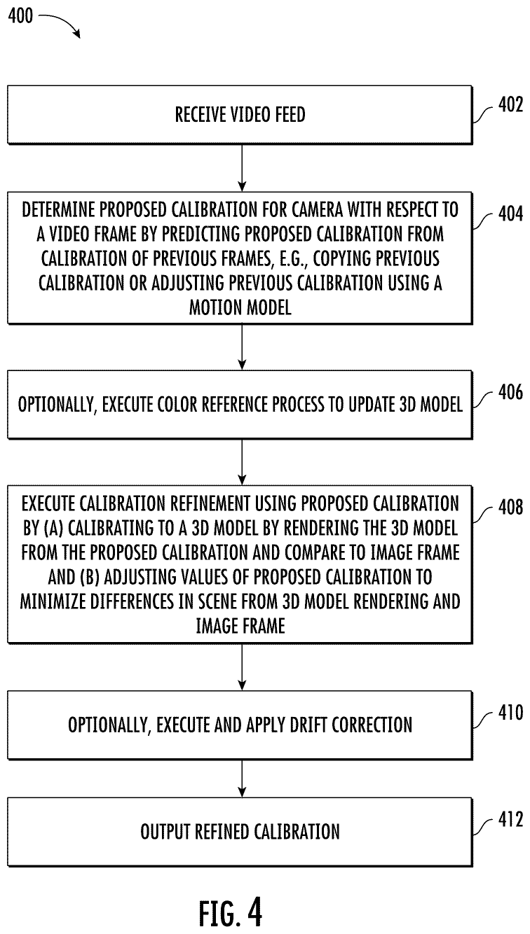

With further reference to FIG. 4, a method of calibrating a drone mounted camera 400 may include receiving a video feed 402, which may or may not be a live video feed. The video feed may be one or more image frames of a video feed. The video feed may be received as described with respect to method 200 or elsewhere herein. The method 400 may include determining a proposed calibration for camera with respect to an image frame by predicting a proposed calibration from calibrations of previous frames, which may include copying the refined calibration of the previous frame or adjusting the previous refined calibration using a motion model 404. In one example, a previous calibration may have been determined according to method 300 or as described with respect to system 10 or elsewhere herein. The method 400 may optionally include executing a color reference process to update the 3D model 406. In various embodiments, the color reference process may be executed as described with respect to method 200, system 10, or elsewhere herein.

The method 400 may include executing a calibration refinement using the proposed calibration by (a) calibrating to a 3D model by rendering the 3D model from the proposed calibration and comparing to the image frame and (b) adjusting values of the proposed calibration to minimize differences in scene from the 3D model rendering and the image frame 408. In various embodiments, the calibration refinement process may be executed as described with respect to method 200, system 10, or elsewhere herein.

The method 400 may optionally include executing and applying drift correction to the refined calibration output from the calibration refinement 410 to generate a refined calibration 412 that has been drift corrected. In various embodiments, drift correction may be executed as described with respect to method 200, system 10, or elsewhere herein.

Method 400 may include outputting the refined calibration 412, which may include a refined calibration that has been subject to drift correction. In various embodiments, the refined calibration may be output to data clients for various uses, such as those described herein.

In one embodiment of method 200, calibration processing is initialized according to method 300 and then proceed with calibration processing of subsequent image frames in the video feed according to method 400.

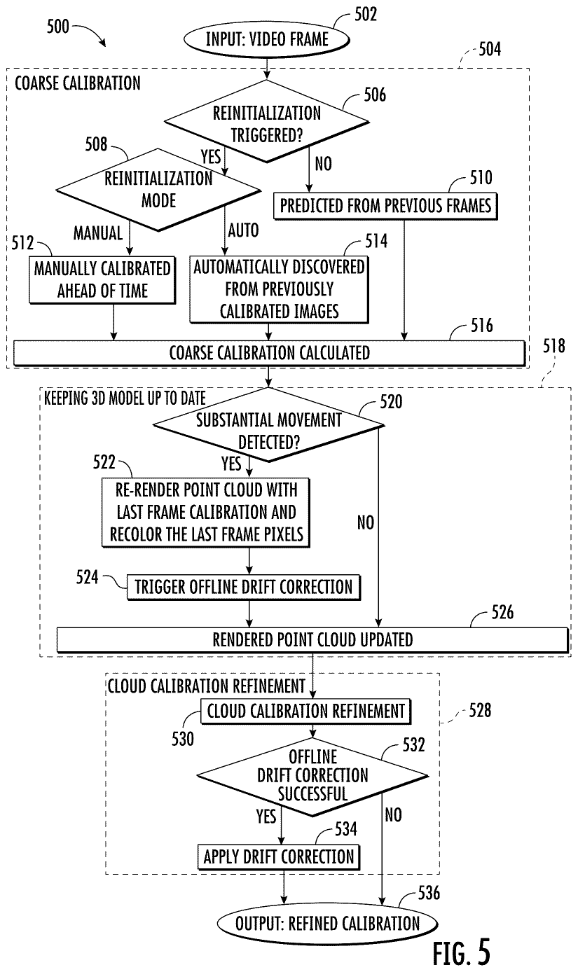

FIG. 5 illustrates a calibration process 500 executable by system 10 according to various embodiments. A video frame may be input 502 into the system 10. The video frame may comprise an image frame of a video feed collected by a camera mounted to a drone. The video frame may be an image frame of a live video feed. The calibration process 500 may include a coarse calibration 504 configured to calculate a coarse calibration 516 comprising a proposed calibration for the video frame. Coarse calibration 504 may include determining if the calibration process should be initialized or reinitialized 506. For example, if the system 10, e.g., calibration processor 20, determines that the video frame is a first image frame of a video feed or that otherwise is not an image frame of a subsequent image frame that has been calibrated, the calibration processor 20 may enter a reinitialization mode 508. Similarly, if the calibration process has been initialized but it is determined that the calibration process should be reinitialized, the calibration processor 20 may enter the reinitialization mode 508. In the reinitialization mode 508, the calibration processor 20 may determine a proposed calibration. For example, the calibration processor 20 may determine a proposed calibration from a manual calibration calibrated ahead of time 512 or automatically discover the proposed calibration from a previously calibrated image 514. In one embodiment, the calibration processor 20 determines which initialization pathway to execute, where the manual calibration 512 is favored if available. In the manual calibration pathway, location of the camera 42 or drone 40 as a proxy for the camera 42 may be matched to a calibration previously calculated at the location. In one configuration, the calibration calibrated ahead of time is not a manual calibration and the calibration is previously calculated using automated matching of an image collected at the location to a rendered view of the 3D model that corresponds to the calibration. The automatic discovery pathway 514 may include comparing the video frame to previously calibrated images to identify one or more calibrated images that match the image depicted in the video frame. In some embodiments, optimizations may be applied to further improve the proposed calibration prior to refinement. For example, features in the video frame may be associated with 3D points relative to the 3D model and the points may be used to solve differences in the previous calibration values to compute a better proposed calibration. In various embodiments, manual calibration ahead of time 512, automatic discovery from previously calibrated images 514, e.g., from a calibration library, or both, may be performed as described above, e.g., with respect to FIGS. 1-3. If it is not determined that initialization or reinitialization is needed, e.g., calibration of a previous video frame has been calculated, the calibration processor 20 may predict a proposed calibration from previous frames 510. For example, the calibration of the previous frame may be copied, or a motion model may be applied to one or more previous frames to better predict a proposed calibration for the video frame.

The system 10 may include an update engine 28 configured to keep the 3D model 22 up to date in an update process 518. In FIG. 5, the 3D model is described as including a point cloud. However, those having skill in the art will appreciate that other 3D models 22 may be used. The update engine 28 may detect if substantial movement is present 520. For instance, the update engine 28 may analyze the current and previous video frames to determine if substantial movement has taken place between the images. If substantial movement 520 is detected, the rendering engine 24 may re-render the 3D model 22 with the last frame calibration and the update engine 28 may direct recolor with last frame pixels 522 to update the rendered point cloud 526. The recoloring may also trigger an offline drift correction process 524. The drift correction process may be as described above. In some embodiments, drift correction or one or more aspects thereof are performed online.

The calibration process 500 may include a calibration refinement process 528 comprising performing a calibration refinement 530, which may be as described above with respect to system 10 and FIGS. 1-4, which may also include drift correction. For example, the camera 42 may be calibrated to the 3D model by rendering the 3D model from the proposed calibration and comparing the rendering to the video frame. Given the proposed calibration, the calibration processor 20 may adjust the calibration values of the proposed calibration such that a comparison between the rendered scene and the video frame is minimized. If drift correction was triggered 522, a determination whether the correction was successful may be made 532. If the correct was successful, the update engine 28 may apply the drift correction 534 and the refined calibration may be output 536. If drift correction was not successful, the correction is not applied, and the refined calibration is output 536 without a correction.

While certain embodiments of the present disclosure are described with respect to a camera 42 onboard a drone 40, the present disclosure applies equally to other moving platforms onto which a camera 42 may be mounted to collect video while the platform undergoes motion or otherwise moves to different locations to collect video from different locations. Additionally, while the present disclosure generally describes calibrating a camera 42 with respect to a golf course, those having skill in the art will appreciate upon reading the present disclosure that the system 10 is not limited to operation within a golf course environment. Indeed, the system 10 may find use in environments wherein calibration of a moving camera 24 is desired, such as in television, cinema, surveillance, concerts, parades, events and gatherings, surveying, or other sporting events, e.g., football, baseball, soccer, racing, track and field, tennis, wrestling, basketball, swimming, among others.

The present disclosure may be implemented in various configurations, such as any of those described above or elsewhere herein. As additional examples, various non-limiting aspects of the present disclosure are provided below.

In a first aspect, a method of calibrating a moving camera, such as a camera mounted to a drone or other movable platform, comprises receiving a video feed comprising sequential image frames captured by the camera; determining, for a current image frame, a proposed calibration by executing at least one of: automatic discovery that detects and matches features in the current image frame to features in previously calibrated reference images, assigns 3D positions to matched features in a 3D model by rendering at those feature locations, and solves for calibration values and sets the proposed calibration for the current image frame; waypoint-based selection that obtains a reference calibration previously generated for a waypoint position and sets the proposed calibration for the current image frame to the reference calibration when the camera satisfies a proximity threshold relative to the waypoint; or prediction from a previous refined calibration obtained for a prior image frame, including copying the previous refined calibration or adjusting the previous refined calibration using a motion model, and setting the proposed calibration for the current image frame accordingly; executing a calibration refinement process that renders the 3D model from the proposed calibration, compares a rendered image to the current image frame, and adjusts calibration values to minimize differences to generate a refined calibration; and outputting the refined calibration.

In an example, the method also includes storing a calibration library comprising previously calibrated reference images and reference calibrations for use in automatic discovery, waypoint-based selection, or both. In the above or another example of the first aspect, the method may include generating a reference calibration by aligning a virtual camera view within the 3D model to a reference image, associating points in the 3D model with pixels in the reference image, and fitting a distortion model. In any of the above or another example of the first aspect, the reference calibration is selected as the proposed calibration when the camera's position satisfies a proximity threshold relative to a waypoint position. In any of the above or another example of the first aspect, the refined calibration includes position coordinates and camera orientation values, camera parameters comprising at least one of focal length or distortion values, or combination thereof. In any of the above or another example of the first aspect, the method further includes minimizing a least-squares cost function between the rendered image and the current image frame and GPU-accelerating residual computations and optimization updates.

In any of the above or another example of the first aspect, the method further includes performing drift correction by detecting accumulated error across sequential frames, correcting a calibration of a reference frame, and gradually incorporating corresponding adjustments into subsequent refinement processes to preserve smooth tracking.

In any of the above or another example of the first aspect, the method includes determining proposed calibrations and executing refinement processes on sequential image frames of the video feed such that each refined calibration is based on a proposed calibration derived from a previous refined calibration. In a further example, refined calibrations are output in real-time, including frame rates up to 60 frames per second and per-frame latency under 300 milliseconds.

In any of the above or another example of the first aspect, automatic discovery includes detecting features in the current image frame and reference images, computing descriptors, matching descriptors to form feature correspondences, and assigning 3D positions to matched features by rendering the 3D model at those feature locations. In a further example, the method includes solving for position, rotation, and translation using non-linear optimization to compute and set the proposed calibration for the current image frame. In still a further example, the method includes evaluating multiple candidate reference images and selecting the proposed calibration that yields the lowest correspondence error as a starting estimate for the calibration refinement process.

In any of the above or another example of the first aspect, rendering includes selecting subsets of points in a point cloud that are visible from the proposed calibration, with point density varying based on distance from the camera position and points out of view omitted. In a further example, streaming visible points into GPU memory and evicting non-visible points as the viewpoint changes to maintain a fixed memory footprint while rendering large point clouds.

In any of the above or another example of the first aspect, the method further includes incorporating colors from calibrated image frames into the 3D model to replace previous colors at corresponding points. In a further example, color updates are triggered when movement thresholds are exceeded, including distance traveled or angular displacement between sequential frames. In either of the above examples, the method may further include rendering the 3D model from the refined calibration to identify visible points and mapping pixel colors from the calibrated image frame to those points.

A second aspect includes a non-transitory computer-readable medium storing instructions that, when executed by one or more processors, cause a system to perform the method of the first aspect or any one or combinations of the further examples of the first aspect.

In a third aspect, a system for calibrating a moving camera, such as a camera mounted to a drone or other movable platform, includes one or more processors; and one or more memories storing instructions that, when executed by the one or more processors, cause the system to: receive a video feed comprising sequential image frames captured by the camera; determine, for a current image frame, a proposed calibration by utilizing a previous refined calibration obtained for a prior image frame, including at least one of: copy the previous refined calibration, or adjust the previous refined calibration using a motion model based on changes in position and orientation across prior frames; execute a calibration refinement process that renders a 3D model from the proposed calibration, compares the rendered image to the current image frame, and adjusts calibration values to minimize differences to generate a refined calibration; and output the refined calibration.

In an example of the third aspect, the update engine performs drift correction by detecting accumulated error across sequential frames and gradually incorporating adjustments into subsequent refinements.

In the above or another example of the third aspect, the system outputs refined calibrations at frame rates up to 60 frames per second or greater. In a further example, the system outputs each refined calibration in under 300 milliseconds per frame.

In any of the above or another example of the third aspect, the system further includes an update engine configured to incorporate colors from calibrated image frames into the 3D model to replace previous colors at corresponding points. In a further example, color updates are triggered when movement thresholds are exceeded, including distance traveled or angular displacement between frames.

In any of the above or another example of the third aspect, the refined calibration includes position coordinates and camera orientation values, camera parameters comprising at least one of focal length or distortion values, or combination thereof.

In a fourth aspect, a system for calibrating a camera mounted to a movable platform includes a calibration processor configured to: receive a video feed from the camera, wherein the video feed comprises a plurality of sequential image frames, determine a proposed calibration for an image frame of the video feed, wherein the proposed calibration comprises calibration values including position coordinates within a coordinate reference frame, camera orientation, or both, execute a calibration refinement process comprising rendering a 3D model of an environment captured in the video feed from the proposed calibration to generate a rendered image, comparing the rendered image to the image frame, and adjusting the calibration values of the proposed calibration to minimize differences between the rendered image and the image frame to generate a refined calibration, and output the refined calibration. The system may perform the calibrations utilizing the video feed and 3D model without additional sensor data from the camera or the movable platform.

In an example, of the fourth aspect, the calibration values comprise position coordinates, camera orientation angles, focal length, and camera distortion parameters. In the above or another example of the fourth aspect, the calibration processor is configured to iteratively adjust the calibration values using optimization to minimize the differences between the rendered image and the image frame. In any of the above or another example of the fourth aspect, the calibration processor is configured to calibrate the camera without receiving or utilizing position data from global positioning system sensors, orientation data from inertial measurement units, lens parameter data from lens encoders, or motion data from accelerometers associated with the camera or the movable platform. In the above or another example of the fourth aspect, the system further comprises a rendering engine communicatively coupled to the calibration processor and configured to render the 3D model from the proposed calibration, wherein the rendering engine comprises a data structure configured for efficient querying of subsets of points in the 3D model visible from the proposed calibration.

In a fifth aspect, a method for calibrating a camera mounted to a movable platform includes receiving a video feed from the camera, wherein the video feed comprises a first image frame, determining a proposed calibration for the first image frame by identifying features in the first image frame, comparing the features in the first image frame to features in a set of previously calibrated reference images to identify at least one reference image having features that match the features in the first image frame, establishing correspondences between the features in the first image frame and 3D positions of the features in a 3D model of an environment captured in the video feed using calibration data associated with the at least one reference image, and solving for calibration values for the camera using the correspondences to generate the proposed calibration, executing a calibration refinement process comprising rendering the 3D model from the proposed calibration to generate a rendered image, comparing the rendered image to the first image frame, and adjusting the calibration values of the proposed calibration to minimize differences between the rendered image and the first image frame to generate a refined calibration for the first image frame, and outputting the refined calibration for the first image frame.

In an example of the fifth aspect, identifying features in the first image frame includes executing computer vision procedures to detect and extract the features. In this or another example of the fifth aspect, establishing correspondences comprises determining the 3D positions of the features in the at least one reference image by rendering the 3D model from the calibration associated with the at least one reference image. In any of the above or another example of the fifth aspect, solving for the calibration values comprises executing nonlinear optimization using the correspondences to generate the proposed calibration. In this or another example of the fifth aspect, the method includes calibrating a second image frame following the first image frame by determining a second proposed calibration by predicting the second proposed calibration from the refined calibration for the first image frame and executing a second calibration refinement process for the second image frame.

In this or another example of the fifth aspect, the refined calibration comprises a first calibration and the method includes performing a second calibration to calibrate a subsequent image frame including predicting a proposed calibration from the subsequent image frame by utilizing the first calibration incorporating a motion model to adjust the first calibration values based on motion between the first image frame and the second image frame. In a further example of the fifth aspect, adjusting the calibration values comprises iteratively adjusting the calibration values using optimization to minimize the differences between the rendered image and the second image frame. In any of the above examples of the fifth aspect, the method may include updating the 3D model by incorporating colors from the first image frame into the 3D model after determining the first calibration for the first image frame.

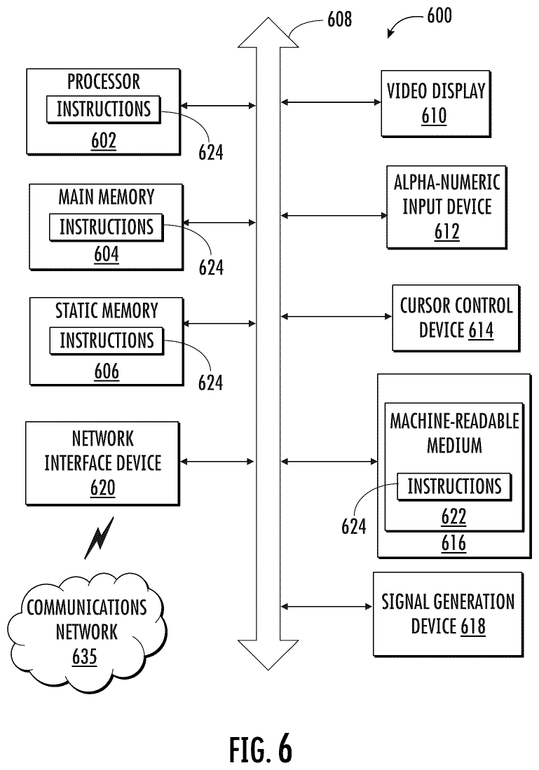

Referring now also to FIG. 6, at least a portion of the methodologies and techniques described with respect to the exemplary embodiments of the system 10 can incorporate a machine, such as, but not limited to, computer system 600, or other computing device within which a set of instructions, when executed, may cause the machine to perform any one or more of the methodologies or functions discussed above. The machine may be configured to facilitate various operations conducted by the system 10. For example, the machine may be configured to, but is not limited to, assist the system 10, such as the calibration processor 20 thereof, by providing processing power to assist with processing loads experienced in the system 10, by providing storage capacity for storing instructions or data traversing the system 10, or by assisting with any other operations conducted by or within the system 10. As another example, the computer system 600 may assist with obtaining video feed data, data transmission, rendering the 3D model 22, updating the 3D model 22, association operations, correspondence operations, data importation, data storage, data translation, data mapping, updates to any thereof, or a combination thereof. As another example, the computer system 600 may assist with output, distribution, or both of calibration data or assembling or compiling of calibration data, modifications, updates, or other data for delivery or distribution to data clients 52.

In some embodiments, the machine may operate as a standalone device. In some embodiments, the machine may be connected to and assist with operations performed by other machines and systems, such as, but not limited to, any functionality, generator, simulator, database, engine, of other functionality described herein, any of which may be provided by such other machines or systems to the machine for use by system 10 in performance of the operations described herein. The machine may be connected with any component in the system 10. In a networked deployment, the machine may operate in the capacity of a server or a client user machine in a server-client user network environment, or as a peer machine in a peer-to-peer (or distributed) network environment. The machine may operate in a cloud environment in which resources are distributed. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The computer system 600 may include a processor 602 (e.g., a central processing unit (CPU), a graphics processing unit (GPU, or both), a main memory 604 and a static memory 606, which communicate with each other via a bus 608. The computer system 600 may further include a video display unit 610, which may be, but is not limited to, a liquid crystal display (LCD), a flat panel, a solid-state display, or a cathode ray tube (CRT). The computer system 600 may include an input device 612, such as, but not limited to, a keyboard, a cursor control device 614, such as, but not limited to, a mouse, a disk drive unit 616, a signal generation device 618, such as, but not limited to, a speaker or remote control, and a network interface device 620. The network interface device 635 may handle data communications for other devices, modules, units, or components of the system 10 or another system or machine.

The disk drive unit 616 may include a machine-readable medium 622 on which is stored one or more sets of instructions 624, such as, but not limited to, software embodying any one or more of the methodologies or functions described herein, including those methods illustrated above. The instructions 624 may also reside, completely or at least partially, within the main memory 604, the static memory 606, or within the processor 602, or a combination thereof, during execution thereof by the computer system 600. The main memory 604 and the processor 602 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system 10 is applicable to software, firmware, and hardware implementations.

In accordance with various embodiments of the present disclosure, methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine-readable medium 622 containing instructions 624 so that a device connected to the communications network 635, another network, or a combination thereof, can send or receive voice, video, or data, and communicate over the communications network 635, another network, or a combination thereof, using the instructions. The instructions 624 may further be transmitted or received over the communications network 635, another network, or a combination thereof, via the network interface device 620.

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that causes the machine to perform any one or more of the methodologies of the present disclosure.

The terms “machine-readable medium,” “machine-readable device,” or “computer-readable device” shall accordingly be taken to include, but not be limited to: memory devices, solid-state memories such as a memory card or other package that houses one or more read-only (non-volatile) memories, random access memories, or other re-writable (volatile) memories; magneto-optical or optical medium such as a disk or tape; or other self-contained information archive or set of archives is considered a distribution medium equivalent to a tangible storage medium. The “machine-readable medium,” “machine-readable device,” or “computer-readable device” may be non-transitory, and, in certain embodiments, may not include a wave or signal per se. Accordingly, the disclosure is considered to include any one or more of a machine-readable medium or a distribution medium, as listed herein and including art-recognized equivalents and successor media, in which the software implementations herein are stored.

The illustrations of arrangements described herein are intended to provide a general understanding of the structure of various embodiments, and they are not intended to serve as a complete description of all the elements and features of apparatus and system 10 that might make use of the structures described herein. Other arrangements may be utilized and derived therefrom, such that structural and logical substitutions and changes may be made without departing from the scope of this disclosure. For example, calibration data outputs may be limited in one or more respects or otherwise customized to a use of a data client 50. For example, position coordinates may be translated into a desired coordinate system used by the data client 50 or a universal coordinate system. In one example, coordinates are provided with respect to the image frames in a grid pattern, per pixel, in a feature related manner, or otherwise. In one example, coordinates may be provided with respect to the position of the drone 40/camera 42. While the system 10 is capable of generating calibration outputs at 60 fps or greater, the present description is not limited to strict sequential camera calibrations of every frame. For example, one or more sequential frames may be skipped such that calibration outputs may be provided for every other image frame, every first and second and fourth and fifth image frame, or other image frame pattern. In another embodiment, the system 10 may be configured to provide calibrations with respect to image frames based on tracking activities taken from analysis of sequential image frames to determine if sufficient movement has occurred to necessitate performance all or a portion of the calibration operations for particular frames.

It is to be appreciated that figures are also merely representative, and the specification and drawings are to be regarded in an illustrative rather than a restrictive sense. Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description. Therefore, it is intended that the disclosure is not limited to the particular arrangement(s) disclosed as the best mode contemplated for carrying out this invention, but that the invention will include all embodiments and arrangements falling within the scope of the appended claims.

Any references to “various embodiments,” “certain embodiments,” “some embodiments,” “one embodiment,” “an embodiment,” or their “example,” “configuration, or “instance” counterparts generally means that a particular element, feature and/or aspect described is included in at least one embodiment but may not refer to the same embodiment. Furthermore, the phrases “in one such embodiment” or “in certain such embodiments,” while generally referring to and elaborating upon a preceding embodiment, are not intended to suggest that the elements, features, and aspects of the embodiment introduced by the phrase are limited to the preceding embodiment; rather, the phrase is provided to assist the reader in understanding the various elements, features, and aspects disclosed herein and it is to be understood that those having ordinary skill in the art will recognize that such elements, features, and aspects presented in the introduced embodiment may be applied in combination with other various combinations and sub-combinations of the elements, features, and aspects presented in the disclosed embodiments. The grammatical articles “one”, “a”, “an”, and “the”, as used in this specification, are intended to include “at least one” or “one or more”, unless otherwise indicated. Thus, the articles are used in this specification to refer to one or more than one (i.e., to “at least one”) of the grammatical objects of the article. By way of example, “a component” means one or more components, and thus, possibly, more than one component is contemplated and may be employed or used in an implementation of the described embodiments. Further, the use of a singular noun includes the plural, and the use of a plural noun includes the singular, unless the context of the usage requires otherwise.

What is claimed is:

1. A system for calibrating a camera that undergoes movement, the system comprising:
one or more processors; and
one or more memories storing instructions that, when executed by the one or more processors, cause the system to:
receive a video feed comprising sequential image frames captured by the camera;
determine a proposed calibration for a current image frame by executing at least one of:
automatic discovery that detects and matches features in the current image frame to features in previously calibrated reference images, assigns 3D positions to matched features in a 3D model by rendering at those feature locations, and solves for calibration values and sets the proposed calibration for the current image frame;
waypoint based selection that obtains a reference calibration previously generated for a waypoint position and sets the proposed calibration for the current image frame to the reference calibration when the camera satisfies a proximity threshold relative to the waypoint; or
prediction from a previous refined calibration obtained for a prior image frame, including copying the previous refined calibration or adjusting the previous refined calibration using a motion model, and setting the proposed calibration for the current image frame accordingly;
execute a calibration refinement process that, using a rendering engine configured to render the 3D model from the proposed calibration, compares a rendered image to the current image frame and adjusts calibration values to minimize differences to generate a refined calibration; and
output the refined calibration.

2. The system of claim 1, wherein the memories store a calibration library comprising previously calibrated reference images and reference calibrations used by both automatic discovery and waypoint based selection to determine the proposed calibration.

3. The system of claim 1, wherein the instructions further cause the system to generate a reference calibration by aligning a virtual camera view within the 3D model to a reference image, associating points in the 3D model with pixels in the reference image, and fitting a distortion model.

4. The system of claim 1, wherein the instructions further cause the system to select the reference calibration as the proposed calibration when the camera's position satisfies a proximity threshold relative to a waypoint position.

5. The system of claim 1, wherein the refined calibration includes position coordinates and camera orientation values.

6. The system of claim 1, wherein the refined calibration further includes camera parameters comprising at least one of focal length or distortion values.

7. The system of claim 1, wherein the instructions further cause the system to determine proposed calibrations and execute refinement processes on sequential image frames of the video feed such that each subsequent refined calibration is based on a proposed calibration derived from a previous refined calibration.

8. The system of claim 7, wherein the instructions further cause the system to output refined calibrations in real time, including frame rates up to 60 frames per second and per frame latency under 300 milliseconds.

9. The system of claim 1, wherein the instructions further cause the system, during automatic discovery, to detect features in the current image frame and reference images, compute descriptors, match descriptors to form feature correspondences, and assign 3D positions to matched features by rendering the 3D model at those feature locations.

10. The system of claim 9, wherein the instructions further cause the system to solve for position, rotation, and translation using non linear optimization to compute and set the proposed calibration for the current image frame.

11. The system of claim 10, wherein the instructions further cause the system to evaluate multiple candidate reference images and select the proposed calibration that yields the lowest correspondence error as a starting estimate for the calibration refinement process.

12. The system of claim 1, wherein the rendering engine comprises a data structure configured for efficient querying of subsets of points in a point cloud that are visible from the proposed calibration, and wherein point density varies with distance from the camera position and points out of view are omitted.

13. The system of claim 12, wherein the instructions further cause the system to stream visible points into GPU memory and evict non visible points as the viewpoint changes to maintain a fixed memory footprint while rendering large point clouds.

14. The system of claim 1, wherein the instructions further cause the system to minimize a least squares cost function between the rendered image and the current image frame and to GPU accelerate residual computations and optimization updates.

15. The system of claim 1, further comprising an update engine, and wherein the instructions further cause the system to incorporate colors from calibrated image frames into the 3D model to replace previous colors at corresponding points.

16. The system of claim 15, wherein the instructions further cause the system to trigger color updates when movement thresholds are exceeded, including distance traveled or angular displacement between sequential frames.

17. The system of claim 15, wherein the instructions further cause the system to render the 3D model from the refined calibration to identify visible points and map pixel colors from the calibrated image frame to those points.

18. The system of claim 1, wherein the instructions further cause the system to perform drift correction by detecting accumulated error across sequential frames, correcting a calibration of a reference frame, and gradually incorporating corresponding adjustments into subsequent refinement processes to preserve smooth tracking.

19. A method for calibrating a moving camera, the method comprising:
receiving a video feed comprising sequential image frames captured by the camera;
determining, for a current image frame, a proposed calibration by executing at least one of:
automatic discovery that detects and matches features in the current image frame to features in previously calibrated reference images, assigns 3D positions to matched features in a 3D model by rendering at those feature locations, and solves for calibration values and sets the proposed calibration for the current image frame;
waypoint-based selection that obtains a reference calibration previously generated for a waypoint position and sets the proposed calibration for the current image frame to the reference calibration when the camera satisfies a proximity threshold relative to the waypoint; or
prediction from a previous refined calibration obtained for a prior image frame, including copying the previous refined calibration or adjusting the previous refined calibration using a motion model, and setting the proposed calibration for the current image frame accordingly;
executing a calibration refinement process that renders the 3D model from the proposed calibration, compares a rendered image to the current image frame, and adjusts calibration values to minimize differences to generate a refined calibration; and
outputting the refined calibration.

20. A system for calibrating a camera that undergoes movement, the system comprising:
one or more processors; and
one or more memories storing instructions that, when executed by the one or more processors, cause the system to:
receive a video feed comprising sequential image frames captured by the camera;
determine, for a current image frame, a proposed calibration by utilizing a previous refined calibration obtained for a prior image frame, including at least one of:
copying the previous refined calibration, or
adjusting the previous refined calibration using a motion model based on changes in position and orientation across prior frames;
execute a calibration refinement process that renders a 3D model from the proposed calibration, compares the rendered image to the current image frame, and adjusts calibration values to minimize differences to generate a refined calibration; and
output the refined calibration, wherein the system outputs refined calibrations at frame rates up to frames per second or greater.
